(19) United States
(12) Patent Application Publication
(10) Pub. No.: US 2016/0038851 A1
(43) Pub. Date: Feb. 11, 2016

(54) METHOD AND SYSTEM FOR ORIFICE CONTROL OF VALVE PRESSURE DROP

(71) Applicant: GTC TECHNOLOGY US, LLC, Houston, TX (US)

(72) Inventors: Michael J. BINKLEY, Glenn Heights, TX (US); SooWoong KIM, Flower Mound, TX (US); Phillip Bradley FLEMING, Keller, TX (US)

(73) Assignee: GTC TECHNOLOGY US, LLC, Houston, TX (US)

(21) Appl. No.: 14/822,637

(22) Filed: Aug. 10, 2015

Related U.S. Application Data
(60) Provisional application No. 62/035,856, filed on Aug. 11, 2014.

(51) Int. Cl. B01D 3/32

(52) U.S. Cl. CPC B01D 3/324

(57) ABSTRACT

The present invention relates to a valve tray for use in a chemical process column. The valve tray includes a plurality of apertures formed therein. A plurality of valves are maintained in a spaced relationship relative to individual apertures of the plurality of apertures. An area of the individual apertures is less than an area of individual valves of the plurality of valves.

### CROSS-REFERENCE TO RELATED APPLICATIONS

This application claims priority to, and incorporates by reference the entire disclosure of, U.S. Provisional Patent Application No. 62/035,856, filed Aug. 11, 2014.

### BACKGROUND

1. Field of the Invention

The present invention relates to fluid-fluid contacting trays and, more particularly, but not by way of limitation, to an improved fluid dispersion device and tray assembly incorporating fixed and/or floating valves used in conjunction with a tray deck orifice of a selectively reduced size.

2. History of the Related Art

It is well known to utilize distillation columns to separate selected components from a multicomponent stream. Generally, such contact columns utilize either trays, packing, or combinations thereof. In certain years the trend has been to replace so-called “bubble caps” by sieve and valve trays in most tray column designs. Valve trays remain a favorable design.

Successful fractionation in the column is dependent upon intimate contact between heavier fluids and lighter fluids. Some contact devices, such as trays, are characterized by relatively high pressure drop and relatively high fluid hold-up. One type of contact apparatus utilizes fluid in the vapor phase to contact fluid in the liquid phase and has become popular for certain applications. Another type of contact apparatus is high-efficiency packing, which is energy efficient because it has low pressure drop and low fluid hold-up. However, these very properties at times make columns equipped with structured packing difficult to operate in a stable, consistent manner. Moreover, many applications simply require the use of trays.

Trays for fractionation columns are commonly designed in two configurations: cross-flow and counter flow. The trays generally consist of a solid tray or deck having a plurality of apertures and are installed on support rings within the column. In cross-flow trays, lighter fluid ascends through the apertures and contacts heavier fluid moving across the tray, through the “active” area thereof. In this area, the heavier fluid and the lighter fluid mix and fractionation occurs. The heavier fluid is directed onto the tray by means of a vertical channel from the tray above. This channel is referred to as the Inlet Downcomer. The heavier fluid moves across the tray and exits through a similar channel referred to as the Exit Downcomer. The location of the downcomers determines the flow pattern of the heavier fluid. If there are two Inlet Downcomers and the heavier fluid is split into two streams over each tray, it is called a two pass tray. If there is only one Inlet and one Outlet Downcomer on opposite sides of the tray, it is called a single pass tray. For two or more passes, the tray is often referred to as a Multipass Tray. The number of passes generally increases as the required (design) flow rate increases. It is the active area of the tray, however, which is of critical concern.

Addressing now select flow designs, a particularly effective tray in process columns is the sieve tray. This tray is constructed with a large number of apertures formed in the bottom surface. The apertures permit the ascending lighter fluid to flow into direct engagement with the heavier fluid that is flowing across the tray from the downcomer described above. When there is sufficient lighter-fluid flow upwardly through the tray, the heavier fluid is prevented from running downwardly through the apertures (referred to as “weeping”). A small degree of weeping is normal in trays while a larger degree of weeping is detrimental to the capacity and efficiency of a tray.

Tray efficiency is also known to be improved in sieve type trays by increasing the froth height of the heavier fluid and reducing the backflow of the heavier fluid flowing across the tray. Froth is created when lighter fluid “bubbles” percolate upwardly through the heavier fluid flowing across the tray. The suspension of the lighter fluid in the heavier fluid prolongs the fluid-fluid contact which enhances the efficiency of the process. The longer the froth is maintained and the higher the froth is established, the greater the fluid-fluid retention. Higher froth requires smaller “bubbles” formed at a sufficiently slow rate. Likewise, backflow occurs beneath the froth when circulating currents of heavier fluid are established during the heavier fluid flow across the plate. This generally forms along the lateral portions thereof. These currents carry the heavier fluid back across the tray in a manner that reduces the concentration-difference driving force for mass transfer. It is the concentration-difference between the lighter fluid and the heavier fluid which enhances the effectiveness of the fluid-fluid contact.

The concentration-difference between the lighter fluid and the heavier fluid can be effected in many ways; some reducing efficiency. For example, as operating pressure increases, the heavier fluid begins to absorb lighter fluid as it moves across a tray. This is above that normally dissolved in the heavier fluid and represents much larger amounts of lighter-fluid bubbles that are commingled or “entrained” with the heavier fluid. This lighter fluid is not firmly held and is released within the downcomer, and, in fact, the majority of said lighter fluid must be released otherwise the downcomer cannot accommodate the heavier fluid/lighter fluid mixture and will flood, thus preventing successful tower operation. This phenomena is generally deemed to occur when operating pressure is such as to produce a lighter fluid density above about 1.0 lbs/cu. ft. and typically amounts to about 10 to 20% of the lighter fluid by volume. For conventional trays, as shown below, the released lighter fluid must oppose the descending frothy lighter fluid/heavier fluid mixture flowing over the weir into the downcomer. In many cases, such opposition leads to poor tower operation and premature flooding.

When a vapor comprises the lighter fluid and a liquid comprises the heavier fluid, there are specific performance issues. Certain performance and design issues are seen in the publication “Distillation Tray Fundamentals”, M. J. Lockett, Cambridge University Press, 1986. Other examples are seen in several prior art patents, which include U.S. Pat. No. 3,338,566 issued to W. Kittel, U.S. Pat. No. 3,729,179 assigned to Fractionation Research, Inc., U.S. Pat. Nos. 3,282,576 and 4,275,021 assigned to Union Carbide Corporation and U.S. Pat. No. 4,603,022 issued to Mitsubishi Jukogyo Kabushiki Kaisha of Tokyo, Japan. A particularly relevant reference is seen in U.S. Pat. No. 4,499,035 assigned to Union Carbide Corporation that teaches a gas-liquid contacting tray with improved inlet bubbling means. A cross-flow tray of the type described above is therein shown with improved means for initiating bubble activity at the tray inlet comprising spaced apart, imperforate wall members extending substantially vertically upwardly and transverse to the liquid flow path. The structural configuration is said to promote activity over a larger tray surface than that afforded by simple perforated tray assemblies. This is accomplished in part by providing a raised region adjacent the downcomer area for facilitating gas ascension therethrough.

U.S. Pat. No. 4,550,000 assigned to Shell Oil Company teaches an apparatus for contacting a liquid with a gas in a relationship between vertically stacked trays in a tower. The apertures in a given tray are provided for the passage of gas in a manner less hampered by liquid coming from a discharge means of the next upper tray. This is provided by perforated housings secured to the tray deck beneath the downcomers for breaking up the descending liquid flow. Such advances in tray designs improve efficiency within the confines of prior art structures. Likewise, U.S. Pat. No. 4,543,219 assigned to Nippon Kayaku Kabushiki Kaisha of Tokyo, Japan teaches a baffle-tray tower. The operational parameters of high gas-liquid contact efficiency and the need for low pressure loss are set forth. Such references are useful in illustrating the need for high efficiency lighter fluid/heavier fluid contact in tray process towers. U.S. Pat. No. 4,504,426 issued to Karl T. Chuang et. al. and assigned to Atomic Energy of Canada Limited is yet another example of gas-liquid contacting apparatus.

Several prior patents have specifically addressed the tray design and the apertures in the active tray deck area itself. For example, U.S. Pat. No. 2,787,453, a 1957 patent, and U.S. Pat. No. 2,853,281, a 1958 patent, disclose directional tab-style fractionating trays that promote tray activity. By way of further example, U.S. Pat. No. 3,146,280 is a 1964 patent teaching a directional float valve. The gas is induced to discharge from the inclined valve in a predefined direction depending on the orientation of the valve in the tray deck. Such valve configurations are often designed for particular applications and flow characteristics. Tray valves with weighted sides and various shapes have thus found widespread acceptance in the prior art. A circular valve structure is shown in U.S. Pat. No. 3,287,004 while a rectangular valve structure is shown in U.S. Pat. No. 2,951,691. Both of these patents issuing to I. E. Nutter, teach specific aspects of gas-liquid contact flow utilizing tray valve systems. Such specialized designs are necessary because lighter fluid/heavier fluid flow problems must be considered for each application in which a tray is fed by a downcomer. The type of flow valve, its orientation, and the lighter-fluid flow apertures for lighter fluid-heavier fluid flow interaction are some of the issues addressed by the present invention.

Addressing specifically now the type of flow valve, its orientation, and the lighter-fluid flow apertures that currently are taught by the prior art. Attention is directed to two patents in which the inventors of the present application, Michael J. Binkley, is a co-inventor. U.S. Pat. Nos. 5,147,584 and 5,120,474, both teach certain valve-tray designs and contact tray assemblies and methods. In the contact tray assemblies and the valve designs, it may be seen that the individual valves whether fixed or floating, are illustrated in the drawings with solid surfaces. In other words, both the front and rear legs, as well as the top surface of the valves, whether floating or fixed, are shown to be of solid construction. Other contact-tray valve assemblies are set forth and shown in U.S. Pat. Nos. 6,145,816; 5,911,922; 5,762,834; and 6,089,550. Each of these patents further illustrate aspects of contact tray assemblies and methods as well as valve designs. Additional patents which should likewise be reviewed relative to contact trays include the following four patents in which the Applicant hereof, Michael J. Binkley, is a co-inventor and include: U.S. Pat. Nos. 5,453,222; 4,956,127; 5,106,556; and 5,192,466. The above-referenced patents and statements with regard to the related art are set forth for purposes of understanding the intricacies of the design considerations in contact-tray assembly and method configurations. It would be an advantage to provide a method of and apparatus for enhanced fluid flow manifesting increased efficiency with a valve design having a deflection tab in either a fixed or floating configuration relative to the tray for enhanced fluid interaction.

### SUMMARY

The present invention relates to fluid-fluid contacting trays and, more particularly, but not by way of limitation, to an improved fluid dispersion device and tray assembly incorporating fixed and/or floating units used in conjunction with a tray orifice of a selectively reduced size. In one aspect, the present invention relates to a valve tray for use in a chemical process column. The valve tray includes a tray surface having an aperture formed therein, the aperture being of an aperture area. A valve is coupled to the tray surface and disposed in a spaced relationship above the aperture. The valve includes a top surface having a surface area, an upstream leg coupled to the top surface, a downstream leg coupled to the top surface, and at least one vane formed on an edge of the top surface. The at least one vane is directed outwardly and downwardly relative to the top surface. The aperture area is smaller than the surface area.

In another aspect, the present invention relates to a method of controlling valve pressure drop in a valve tray. The method includes forming a valve tray having an aperture formed therein. The aperture facilitates passage of a first fluid therethrough. A valve is positioned in a spaced relationship over the aperture. The first fluid flowing upwardly through the aperture is mixed with a second fluid flowing downwardly across the valve tray. The aperture is of restricted size relative to the valve to facilitate control of pressure drop across the valve.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1 is a perspective view of a packed column with various sections cut away for illustrating, diagrammatically, a variety of tower in accordance with an embodiment of the present invention;

FIG. 2 is a diagrammatic, side-elevational, cross-sectional view of a downcomer-tray assembly secured within a process tower and illustrating the flow of heavier fluid and lighter fluid thereacross in accordance with an embodiment of the present invention;

FIG. 3 is a top-plan, diagrammatic view of a tray illustrating efficiency problems with fluid flow transit in accordance with an embodiment of the present invention;

FIG. 4A is a top view of a tray orifice having a plurality of apertures according to an exemplary embodiment;

FIG. 4B is a top view of a tray orifice having restricted central portion according to an exemplary embodiment;

FIG. 4C is a top view of a trapezoidal tray orifice according to an exemplary embodiment;

FIG. 5 is a top view of a fixed valve according to an exemplary embodiment;

FIG. 6 is an end view of the valve of FIG. 5 according to an exemplary embodiment;

FIG. 7A is a top view of a valve having a tab according to an exemplary embodiment;

FIG. 7B is a cross-sectional view of the valve of FIG. 7A according to an exemplary embodiment;

FIG. 8 is a cross-sectional view of a floating valve according to an exemplary embodiment;

FIG. 9 is a top view of a valve positioned over an orifice according to an exemplary embodiment; and

FIG. 10 is a top view of a valve positioned over an orifice according to an exemplary embodiment.

### DETAILED DESCRIPTION

Various embodiments of the present invention will now be described more fully with reference to the accompanying drawings. The invention may, however, be embodied in many different forms and should not be construed as limited to the embodiments set forth herein.

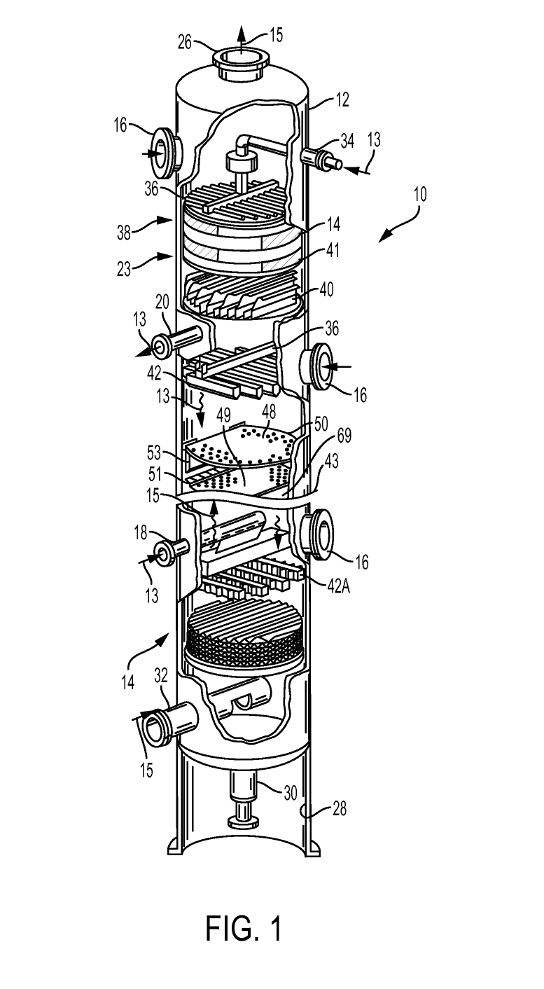

Referring first to FIG. 1, there is shown a fragmentary, perspective view of an illustrative packed exchange tower or column with various sections cut away for showing a variety of tower internals and the utilization of one embodiment of an improved high-capacity tray assembly. The exchange column 10 of FIG. 1 comprises a cylindrical tower 12 having a plurality of packing bed layers 14 and trays disposed therein. A plurality of manways 16 is likewise constructed for facilitating access to the internal region of the tower 12. Also provided are side stream draw-off line 20, heavier-fluid side feed line 18, and side stream lighter-fluid feed line or reboiler return line 32. A reflux return line 34 is provided atop the column 10.

In operation, heavier fluid 13 is fed into the column 10 through reflux return line 34 and side stream feed-input feed line 18. The heavier fluid 13 flows downwardly through the tower and ultimately leaves the tower either at side stream draw-off line 20, or at bottom-stream draw-off line 30. In the case of a vapor-liquid tower, the heavier fluid 13, during its downward flow, is depleted of some material which evaporate from it as it passes through the trays and packing beds, and is enriched or added to by material which condenses into it out of the lighter fluid stream.

Still referring to FIG. 1, the exchange column 10 is diagrammatically cut in half for purposes of clarity. In this illustration, the column 10 includes a lighter-fluid outlet in overhead line 26 disposed atop the tower 12 and a lower skirt 28 disposed in the lower region of the tower 12 around bottom stream takeoff line 30 coupled to a reboiler (not shown). Reboiler return conduit 32 is shown disposed above the skirt 28 for recycling lighter fluid therein upwardly through the trays and/or packing layers 14. Reflux from condensers is provided in the upper tower region 23 through entry conduit 34 wherein reflux is distributed throughout a distributor 36 across upper packing bed 38. It may be seen that the upper packing bed 38 is of the structured packing variety. The regions of the exchange column 10 beneath the upper packing bed 38 are shown for the purpose of illustration and include a heavier fluid collector 40 disposed beneath a support grid 41 in support of the upper structured packing 38. The column 10 is presented with cut-line 43 for illustrating the fact that the tower internals arrangement is diagrammatical only and is provided for referencing various component arrays therein.

Referring still to FIG. 1, an assembly of a pair of trays is also shown for purposes of illustration. In many instances, process columns contain only packing, only trays, or combinations of packing and trays. The present illustration is, however, a combination for purposes of discussion of the overall tower and its operation. A trayed column usually contains a plurality of trays 48 of the type shown herein. In many instances, the trays 48 are valve or sieve trays. Valve trays, comprising the subject matter of the present invention, are herein shown. Such trays comprise plates which are punched or slotted in construction. Within the scope of the invention and for the purposes of the description of various embodiments herein, the configuration referred to as a “valve” or “unit” includes anything at the intersection of and facilitating the dispersion contact between a lighter fluid and a heavier fluid. The lighter fluid and the heavier fluid engage at or along the tray. Optimally, the lighter-fluid and heavier-fluid flows reach a level of stability. With the utilization of appropriate downcomers, to be described in more detail below, this stability may be achieved with a relatively low flow rate permitting the ascending lighter fluid to mix with the descending heavier fluid. In some embodiments of sieve tray or fixed valve trays, no downcomers are used and the lighter fluid and the heavier fluid use the same openings, alternating as the respective pressures change.

In the present embodiment, cross-flow valve trays 48 and 49 and downcomers 53 and 69 are illustrated. Tray 48 is constructed with a plurality of floating valves. Tray 49 also illustrates a raised inlet section 51 beneath downcomer 53, which is substantially planar, formed with a plurality of apertures, and which may include a series of momentum deflector barriers, as will be described below. The raised inlet area is described in more detail in U.S. Pat. No. 4,956,127 (the '127 Patent). Corrosion is another consideration in designing packed towers and for the selection of the material, design, and the fabrication of the tower internals.

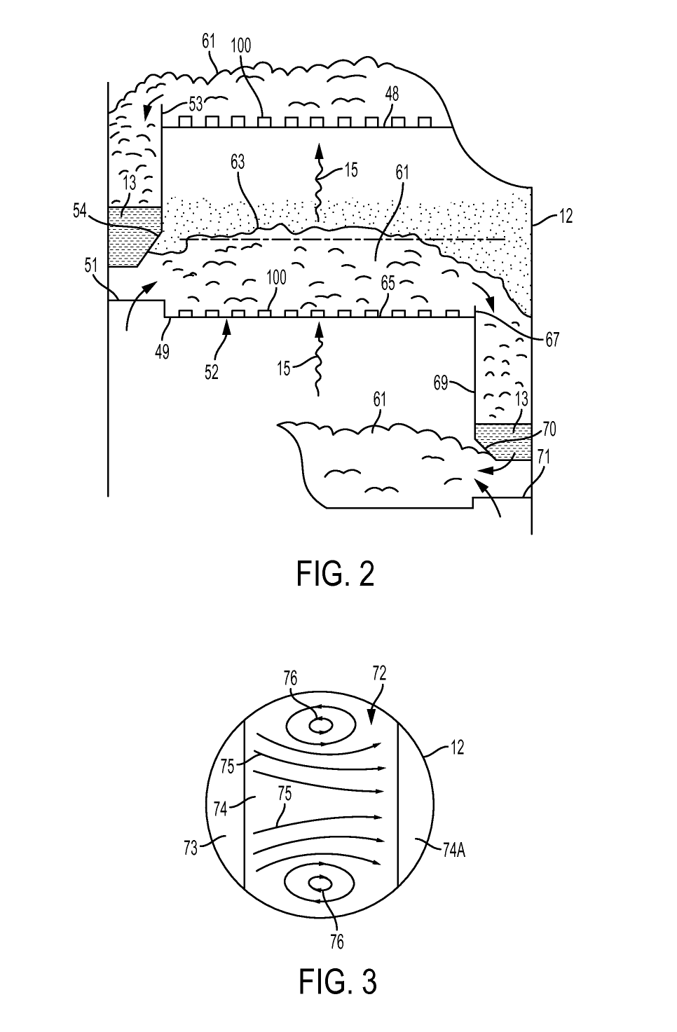

FIG. 2 illustrates a side-elevational, cross-sectional, diagrammatic view of the trays 48 and 49 of FIG. 1. An upper tray 48 comprises a first valved panel. The lower tray 49 is also of generally planar construction across its central active area 52, having a plurality of valves 100 mounted thereon, disposed therein, or formed therefrom as diagrammatically shown. Heavier fluid 13 travels down a downcomer 53 having a straight, sloped, tapered or mitered bottom section 54, from tray 48 disposed thereabove. The tapered section 54 of the downcomer provides a clearance angle for lighter fluid flow from the active inlet area, which clearance angle affords a horizontal flow vector to the lighter fluid vented through a flat or raised panel 51. The heavier fluid 13 engages lighter fluid 15 discharged from the active panel area 51 beneath the downcomer 53.

Still referring to FIG. 2, the froth 61 extends with a relatively uniform height, shown in phantom by line 63 across the width of the tray 49 to the opposite end 65 where a weir 67 is established for maintaining the froth height 63. The accumulated froth at this point flows over the top of the weir 67 into associated downcomer 69 that carries the froth downwardly into a lower region 70 where the heavier fluid accumulates and disperses upon active inlet region 71 therebeneath. Again active inlet region 71 is shown herein diagrammatically for purposes of illustration only. As stated herein, the area of holes and perforations for a single cross-flow plate establish the active length of the plate and the zone in which the froth 61 is established. It should be noted that the present invention would also be applicable to multiple downcomer configurations, wherein the downcomers and raised, active inlet areas may be positioned in intermediate areas of the trays as also described below. By increasing the total active area of active inlet areas 51 and 71, greater capacity and efficiency is achieved. It is also the manner of flow of the heavier fluid 13 across the tray 49 which is critical to tray efficiency.

FIG. 3 illustrates a flow diagram across a conventional tray. The prior art tray 72 is illustrated herein as a round unit having a first conventional downcomer for feeding heavier fluid upon an underlying panel 73 and then to the tray 74. A second downcomer 74A carries heavier fluid away from the tray. A plurality of arrows 75 illustrates the non-uniform flow of heavier fluid 13 typically observed across a conventional prior art tray which does not address the circulation issue. Circular flow is shown to be formed on both sides of the plate lateral to the direction of primary flow. The formation of these retrograde flow areas, or recirculation cells 76, decreases the efficiency of the tray. Recirculation cells 76 are the result of retrograde flow near the walls of the process column and this backflow problem becomes more pronounced as the diameter of the column increases. With the increase in retrograde flow and the resultant stagnation effect from the recirculation cells, concentration-difference driving force for mass transfer between the counter-flowing streams is reduced. The reduction in concentration-difference driving force will result in more contact or height requirement for a given separation in the column. Although back mixing is but a single aspect of plate efficiency, the reduction thereof is provided concurrently with the other advantages hereof. Reference is again made to the plate efficiency discussion set forth in above referenced '127 Patent.

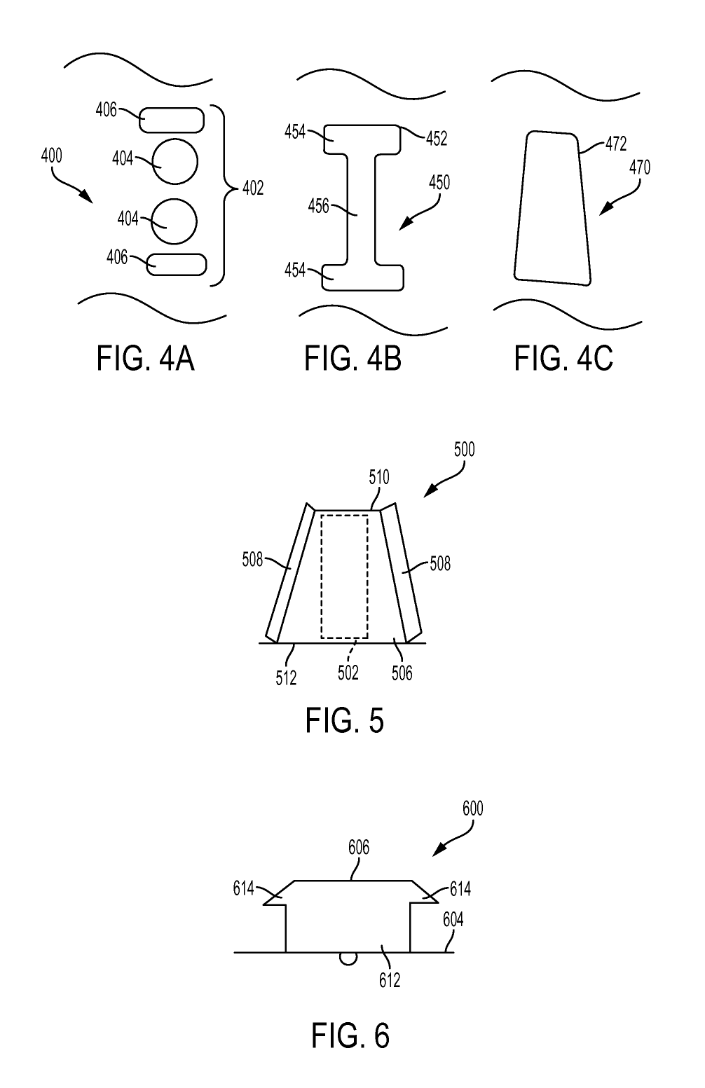

FIG. 4A is a top view of a tray orifice 402. In an embodiment, a valve tray 400 includes a plurality of orifices 402 formed therein. The plurality of orifices 402 includes a plurality of apertures 404 and two slots 406. In a typical embodiment, the plurality of apertures 404 includes two apertures each having a generally round shape; however, in other embodiments any number or shape of apertures could be utilized. In a typical embodiment, a valve (not shown) is secured to the tray 400 via the two slots 406. In various embodiments, the valve may be, for example, a fixed valve or a floating valve. Vapor ascends upwardly through the plurality of apertures 404 for interaction and mass transfer with a second fluid on the a surface of the tray 400. In a typical embodiment, a combined area of the plurality of apertures 404 is less than a surface area of the valve (not shown). Thus, the two apertures restrict ascension of vapor upwardly through the tray 400. In a typical embodiment, a width of the valve is approximately 1.15 to approximately 2.0 times an open area associated with the plurality of apertures 404. That is the open area of each aperture of the plurality of apertures 404 is approximately 87% to approximately 50% of the surface area of the valve.

FIG. 4B is a top view of a tray orifice 452. In an embodiment, a tray 450 includes a plurality of orifices 452. The each orifice of the plurality of orifices 452 includes opposed ends 454 and a central portion 456. The opposed ends 454 have a greater lateral width than the central portion 456 thereby imparting a capital I shape to the plurality of orifices 454. In a typical embodiment, a valve (not shown) is secured in the opposed ends 454. In various embodiments, the valve may be, for example, a fixed valve or a floating valve. Vapor ascends upwardly through the central portion 456 for interaction and mass transfer with a second fluid on the a surface of the tray 450. In a typical embodiment, an area of the central portion 456 is less than a surface area of the valve (not shown). In a typical embodiment, a width of the valve is approximately 1.15 to approximately 2.0 times greater than an open area associated with the central portion 456. That is the open area of each orifice of the plurality of orifices 452 is approximately 87% to approximately 50% of the surface area of the valve. Thus, the central portion restricts ascension of vapor upwardly through the tray 450. FIG. 4C is a top view of a tray orifice 472. In an embodiment, a tray 470 includes a plurality of orifices 472. The plurality of orifices 472 have a generally trapezoidal shape. In a typical embodiment, a valve (not shown) is secured in a spaced relationship relative to the orifice 472. In a typical embodiment, a width of the valve is approximately 1.15 to approximately 2.0 times greater than an open area associated with the orifice 472. That is the open area of each orifice of the plurality of orifices 472 is approximately 87% to approximately 50% of the surface area of the valve. As will be discussed hereinbelow, in a typical embodiment, the valve may be at least one of a fixed valve or a floating valve.

FIG. 5 is a top view of a valve 500. The valve 500 is disposed in a spaced relationship relative to an orifice 502 in a tray deck. In a typical embodiment, the orifice 502 may be similar to those shown in FIGS. 4A-4C. The valve 500 includes a central portion 506, which central portion 506 is spaced from the orifice 502. As shown by way of example in FIG. 5, the central portion 506 exhibits a generally trapezoidal shape; however, in other embodiments, valves utilizing principles of the invention may have central portions of any shape. An upstream leg 512 and a downstream leg 510 support the central portion and maintain the central portion 506 in the spaced relationship with the orifice 502. A vane 508 is formed on either side of the central portion 506. The vanes 508 extend outwardly and downwardly from the central portion 506. During operation, the vanes 508 direct ascending fluid downwardly onto the tray deck thereby facilitating fluid interaction.

Still referring to FIG. 5, the central portion 506 extends beyond the edges of the orifice 502 in both a length-wise and a width-wise direction. Thus, the central portion 506 has a surface area that is larger than an area of the orifice 502. In a typical embodiment, the central portion is approximately 1.15 to approximately 2.0 times larger than an area of the orifice 502. That is an open area of the orifice 502 is approximately 87% to approximately 50% of the surface area of the central portion 506 of the valve 500. The valve cover width to orifice width ratio may range from lower ratio of about 1.15 to a higher ratio of about 4.0. The preferred ratio, depending on the specifics of the application, is in the range of 1.3-2.3. Such an arrangement restricts passage of the lighter fluid ascending through the orifice 502 and provides proper pressure drop control for design-range requirements. Such an arrangement also allows a larger escape area for ascending fluid thereby increasing capacity resulting from lower velocity escape and reduced spray heights. Chances of fouling are also reduced as a result of the larger escape area. Additional information regarding the valve cover width to orifice width ratio is provided in the following table.

TABLE 1
Ratio of Valve width/Orifice width

| | |
|---|---|
| Minimum | Min Ratio @ 46/40 = 1.15 |
| Standard | Std Ratio @ 26/20 = 1.3 |
| Preferred | Preferred Ratio @ 32/15 = 2.13 RATIO |
| (~cost vs. performance) | |
| Maximum | Max Ratio @ 40/10 = 4.0 |

FIG. 6 is an end view of the valve 500. The upstream leg 512 includes barriers 614 extending from either side of an upper aspect of the upstream leg 512. The barriers 614 have a width and a height generally equal to that of the vanes 508. Thus, the barriers 614 effectively “close off” an end portion of the vanes 508 and obstruct fluid flow therethrough. By closing off the corners between the upstream leg 512 and the vanes 508, a more uniform mixing contact from the valve 500 is accomplished.

Referring to FIGS. 4A-6 collectively, the vanes 508 direct ascending fluid in a downward direction thereby creating a vena contracta between a lower edge of the vanes 508 and a tray deck. Such a phenomenon encourages the ascending fluid to distribute across the tray deck and mix with heavier fluid moving laterally, thereby improving the contact efficiency.

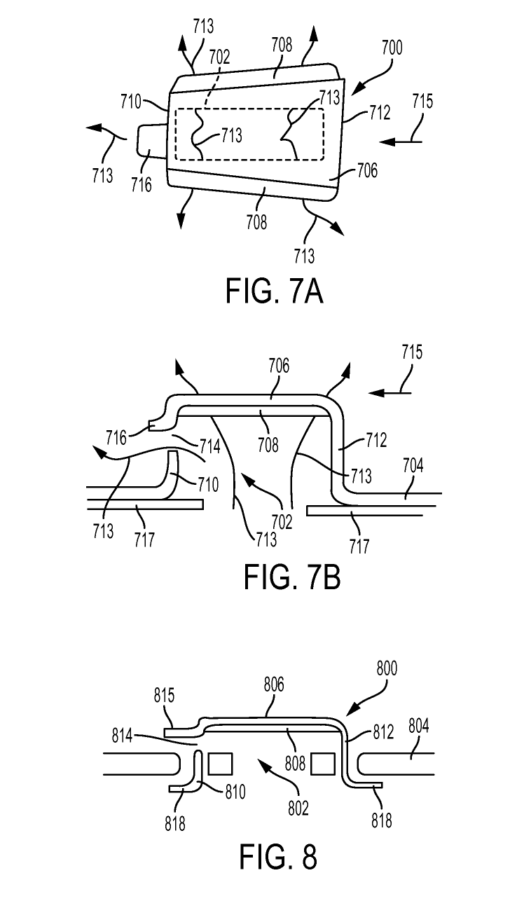

FIG. 7A is a top view of a valve 700. FIG. 7B is a cross-sectional view of the valve 700. The valve 700 is disposed in a spaced relationship relative to an orifice 702 in a tray deck 704. In a typical embodiment, the orifice 702 may be similar to those shown in FIGS. 4A-4C. The valve 700 includes a central portion 706, which central portion 706 is spaced from the orifice 702. As shown by way of example in FIG. 5, the central portion 706 exhibits a generally trapezoidal shape; however, in other embodiments, valves utilizing principles of the invention may have central portions of any shape. An upstream leg 712 and a downstream leg 710 support the central portion 706 and maintain the central portion 706 in the spaced relationship with the orifice 702. In a typical embodiment, an area of the central portion 706 is approximately 1.15 to approximately 2.0 times larger than an open area of the orifice 702. That is an open area of the orifice 702 is approximately 87% to approximately 50% of the surface area of the central portion 706 of the valve 700. In various embodiments, a secondary plate is secured to an underside of the tray deck 704 beneath the orifice 702. The secondary plate reduces a size of the orifice 702 relative to the valve 700 as noted above. In various embodiments an orifice 714 is disposed in the downstream leg 710. A tab 716 is formed adjacent to the orifice 714 for directing fluid emerging from the orifice 714 in a desired direction. A vane 708 may be formed on either side of the central portion 706. The vanes 708 extend outwardly and downwardly from the central portion 706.

Still referring to FIGS. 7A-7B, the vanes 708 direct ascending fluid 713 in a downward direction thereby creating a vena contracta between a lower edge of the vanes 708 and the tray deck 704. Such a phenomenon encourages the ascending fluid 713 to distribute across the tray deck and mix with heavier fluid 715 moving laterally, thereby reducing pressure drop across the valve 700 and improving the contact efficiency.

FIG. 8 is a cross-sectional side view of a valve 800. The valve 800 is disposed in a spaced relationship relative to an orifice 802 in a tray deck 804. In a typical embodiment, the orifice 802 is similar to at least one of those shown in FIGS. 4A-4C. The valve 800 includes a central portion 806, which central portion 806 is spaced from the orifice. In a typical embodiment, the central portion 806 exhibits a generally trapezoidal shape; however, in other embodiments, valves utilizing principles of the invention may have central portions of any shape. In a typical embodiment, an area of the central portion 806 is approximately 1.15 to approximately 2.0 times larger than an open area of the orifice 802. That is an open area of the orifice 802 is approximately 87% to approximately 50% of the surface area of the central portion 806 of the valve 800. An upstream leg 812 and a downstream leg 810 support the central portion and maintain the central portion 806 in the spaced relationship with the orifice. In various embodiments an orifice 814 is disposed in the downstream leg 810. A tab 816 is formed adjacent to the orifice 814 for directing fluid emerging from the orifice 814 in a desired direction.

Still referring to FIG. 8, a securement lip 818 extends from a lower aspect of each of the upstream leg 812 and the downstream leg 810. The securement lip 818 secures the valve 800 with respect to the orifice 802 and restricts the range of the valve 800 from the tray deck 804. In a typical embodiment, the valve 800 may translate in along a vertical axis relative to the tray deck 804. Thus, a height of the valve 800 is dictated by a volume of fluid passing through the orifice 802. During operation of a tower, an upward flow of fluid through the orifice 802 lifts the valve 800 from the tray deck 804 until the securement lips 818 come into contact with an underside of the tray deck 804. In this manner, the valve 800 is able to “float” with respect to the tray deck 804. The securement lip 818 defines an upper limit of movement of the valve 800. A vane 808 is formed on either side of the central portion 806. The vanes 808 extend outwardly and downwardly from the central portion 806.

Still referring to FIG. 8, the vanes 808 direct ascending fluid in a downward direction thereby creating a vena contracta between a lower edge of the vanes 808 and the tray deck 804. Such a phenomenon encourages the ascending fluid to distribute across the tray deck and mix with heavier fluid moving laterally, thereby improving the contact efficiency.

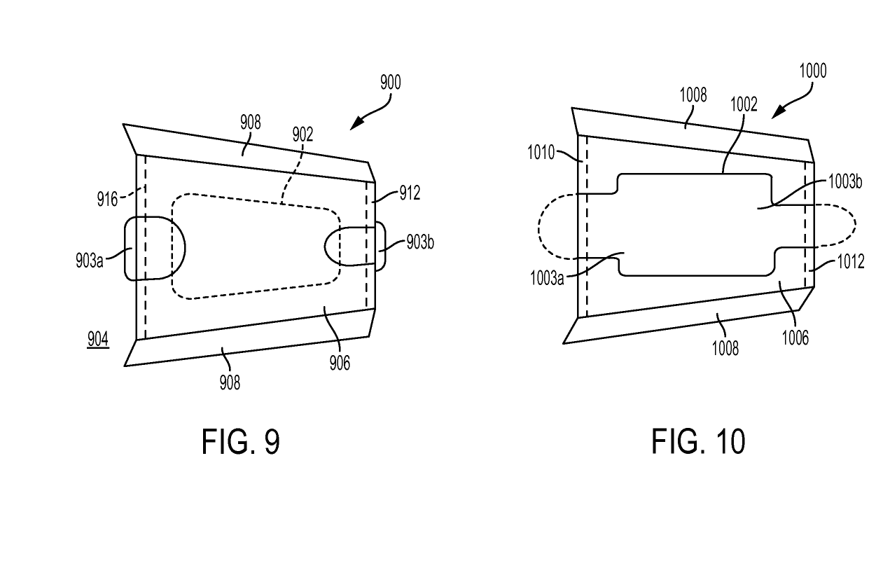

FIG. 9 is a top view of a valve 900 positioned over an orifice 902 formed in a tray deck 904. As shown in FIG. 9, the orifice 902 is generally trapezoidal in shape and includes securement slots 903a and 903b. The valve 900 includes a central portion 906 positioned above and in a spaced relationship relative to the orifice 902. In a typical embodiment, an area of the central portion 906 is approximately 1.15 to approximately 2.0 times larger than an open area of the orifice 902. That is an open area of the orifice 902 is approximately 87% to approximately 50% of the surface area of the central portion 906 of the valve 900. An upstream securement leg 910 and a downstream securement leg 912 extend from the central portion 906 and are arranged substantially perpendicular thereto. The upstream securement leg 910 extends through the securement slot 903a and the downstream securement leg 912 extends through the securement slot 903b. A portion of the upstream securement leg 910 that extends through the securement slot 903a is bent inwardly towards the downstream securement leg 912. Likewise, a portion of the downstream securement leg 912 that extends through the securement slot 903b is bent inwardly towards the upstream securement leg 910. The upstream securement leg 910 and the downstream securement leg 912 secure the valve 900 to the tray deck 904 and prevent removal of the valve 900 therefrom.

Still referring to FIG. 9, a pair of vanes 908 extend laterally and downwardly from the central portion 906. In a typical embodiment, each vane of the pair of vanes 908 has a width in the range of approximately 3 mm to approximately 12 mm. In addition, each vane of the plurality of vanes 908 is angled downwardly from the central portion 906 at an angle of approximately 30 degrees to approximately 45 degrees.

FIG. 10 is a top view of a valve 1000 positioned over an orifice 1002 formed in a tray deck 1004. As shown in FIG. 10, the orifice 1002 includes narrow portions 1003a and 1003b. The valve 1000 includes a central portion 1006 positioned above and in a spaced relationship relative to the orifice 1002. In a typical embodiment, an area of the central portion 1006 is approximately 1.15 to approximately 2.0 times larger than an open area of the orifice 1002. That is an open area of the orifice 1002 is approximately 87% to approximately 50% of the surface area of the central portion 1006 of the valve 1000. An upstream securement leg 1010 and a downstream securement leg 1012 extend from the central portion 1006 and are arranged substantially perpendicular thereto. The upstream securement leg 1010 extends through the narrow portion 1003a and the downstream securement leg 1012 extends through the narrow portion 1003b. A portion of the upstream securement leg 1010 that extends through the narrow portion 1003a is bent outwardly away from the downstream securement leg 1012. Likewise, a portion of the downstream securement leg 1012 that extends through the narrow portion 1003b is bent outwardly away from the upstream securement leg 1010. The upstream securement leg 1010 and the downstream securement leg 1012 secure the valve 1000 to the tray deck 1004 and prevent removal of the valve 1000 therefrom.

Still referring to FIG. 10, a pair of vanes 1008 extend laterally and downwardly from the central portion 1006. In a typical embodiment, each vane of the pair of vanes 1008 has a width in the range of approximately 3 mm to approximately 12 mm. In addition, each vane of the plurality of vanes 1008 is angled downwardly from the central portion 1006 at an angle of approximately 30 degrees to approximately 45 degrees.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

What is claimed is:

1. A valve tray for use in a chemical-process column, the valve tray comprising:
a tray surface having an aperture formed therein, the aperture being of an aperture area;
a valves coupled to the tray surface and disposed in a spaced relationship above the aperture, the valve comprising:
a top surface having a surface area;
an upstream leg coupled to the top surface;
a downstream leg coupled to the top surface;
at least one vane formed on an edge of the top surface, the at least one vane being directed outwardly and downwardly relative to the top surface; and
wherein the aperture area is smaller than the surface area.

2. The valve tray according to claim 1, wherein the aperture is trapezoidal shaped.

3. The valve tray according to claim 1, wherein the aperture comprises opposed ends of a lateral width and a central portion of a reduced lateral width relative to the opposed ends.

4. The valve tray according to claim 1, wherein the aperture is bordered by two slots.

5. The valve tray according to claim 1, wherein the valve is a fixed valve.

6. The valve tray according to claim 1, wherein the valve is a floating valve.

7. The valve tray according to claim 1, wherein the valve comprises an orifice formed in the downstream leg.

8. The valve tray according to claim 7, wherein the valve comprises a tab formed adjacent to the orifice.

9. The valve tray according to claim 1, wherein the valve comprises two vanes formed on oppositely-disposed edges of the top surface.

10. The valve tray according to claim 1, the aperture area is in the range of approximately 87% to approximately 50% of the surface area.

11. The valve tray according to claim 1, wherein the vane directs ascending fluid in a downward direction thereby creating a vena contracta between a lower edge of the vane and the tray surface.

12. A method of controlling valve pressure drop in a valve tray, the method comprising:
forming a valve tray having an aperture formed therein, the aperture facilitating passage of a first fluid therethrough;
positioning a valve in a spaced relationship over the aperture;
mixing the first fluid flowing upwardly through the aperture with a second fluid flowing downwardly across the valve tray;
wherein the aperture is of restricted size relative to the valve to facilitate control of pressure drop across the valve.

13. The method of claim 12, wherein the restricted aperture size reduces spray height.

14. The method of claim 12, comprising creating a vena contracta between the valve and the valve tray via a vane disposed on an edge of the valve.

15. The method of claim 14, wherein the vane directs the first fluid outwardly and downwardly relative to the valve.

16. The method of claim 14, wherein the vena contracta encourages the first fluid to distribute across the valve tray.

17. The method of claim 12, wherein the aperture is trapezoidal shaped.

18. The method of claim 12, wherein the aperture comprises opposed ends of a lateral width and a central portion of a reduced lateral width relative to the opposed ends.

19. The method of claim 12, wherein an area defined by the aperture is in the range of approximately 87% to approximately 50% of a surface area of a cover associated with the valve.

20. The method of claim 12, wherein the valve comprises two vanes formed on oppositely-disposed edges of the top surface.
